(19) United States
(12) Patent Application Publication
(10) Pub. No.: US 2026/0072222 A1
(43) Pub. Date: Mar. 12, 2026

(54) Chip, Optical/Electrical Module, and Optical Communication Device

(71) Applicant: HUAWEI TECHNOLOGIES CO., LTD., Shenzhen (CN)

(72) Inventors: Mengdie Sun, Shenzhen (CN); Hongmin Chen, Shenzhen (CN); Wei Li, Shenzhen (CN); Xin Chen, Wuhan (CN); Shihao Sun, Shenzhen (CN); Xi Kong, Shenzhen (CN)

(73) Assignee: HUAWEI TECHNOLOGIES CO., LTD., Shenzhen (CN)

(21) Appl. No.: 19/389,829

(22) Filed: Nov. 14, 2025

Related U.S. Application Data
(63) Continuation of application No. PCT/CN2023/139429, filed on Dec. 18, 2023.

(30) Foreign Application Priority Data
May 17, 2023 (CN) 202310559197.1

(51) Int. Cl. G02B 6/42; H04B 10/25; H04B 10/40

(52) U.S. Cl. CPC G02B 6/4246; H04B 10/25; H04B 10/40

(57) ABSTRACT

A chip includes a substrate, a transmitter, and a receiver. A quantity of side walls of the substrate is greater than four, the transmitter is located in a first region of the substrate, the receiver is located in a second region of the substrate, and a part of the substrate located in the first region has a first side wall on a side that is of the first region and that faces the second region, that is, a shape of the substrate is not a rectangle. In addition, a part of the first region that is located on a side that is of the first side wall and that is away from the second region is a protruding part of the first region relative to the second region, so that the first region and the second region form an abnormal-shaped region.

### CROSS-REFERENCE TO RELATED APPLICATIONS

This is a continuation of Int'l Patent App. No. PCT/CN2023/139429 filed on Dec. 18, 2023, which claims priority to Chinese Patent App. No. 202310559197.1 filed on May 17, 2023, both of which are incorporated by reference.

### TECHNICAL FIELD

This disclosure relates to the field of integrated circuit manufacturing, and in particular, to a chip, an optoelectronic module, and an optical communication device.

### BACKGROUND

With the development of internet technologies, people's requirements for network bandwidth are surging. Flexible optical networks are proposed, coherent technologies are developed, and optical network integration is improved. This effectively meets the people's increasing requirements. With continuous improvement of integration of an optical communication system, an optical/electrical module, or an optoelectronic module, is developing toward a high rate, miniaturization, low costs, low power consumption, and the like. The optoelectronic module may include at least one chip, and the chip may have a transmitter and a receiver. The transmitter and the receiver are used as core interfaces for conversion from an electrical domain to an optical domain and conversion from an optical domain to an electrical domain in an optical network, and are widely used in a large-capacity and long-distance coherent communication system. A form of the chip directly affects a size of the entire optoelectronic module. Currently, a shape of the chip is a rectangle, and there is an area waste. This is not conducive to reducing costs of the chip and the size of the optoelectronic module.

### SUMMARY

In view of this, embodiments of this disclosure provide a chip, an optoelectronic module, and an optical communication device, to reduce an area waste of the chip and reduce costs of the chip.

A first aspect of embodiments of this disclosure provides a chip, including a substrate, and a transmitter and a receiver that are located on a first side of the substrate. A quantity of side walls of the substrate is greater than four, the transmitter is located in a first region of the substrate, the receiver is located in a second region of the substrate, the first region is adjacent to the second region, and a part of the substrate located in the first region has a first side wall on a side that is of the first region and that faces the second region. In other words, a shape of the substrate is not a rectangle. In addition, a part, of the first region, that is located on a side that is of the first side wall and that is away from the second region is a protruding part of the first region relative to the second region, so that the first region and the second region form an abnormal-shaped region. In this way, the first region and the second region may be respectively designed based on an area of the transmitter and an area of the receiver, and do not need to adapt to a regular rectangle of the chip. This reduces an area of the chip to some extent, reduces an area waste of the chip, and reduces costs of the chip. This also correspondingly reduces a size of the optoelectronic module, and expands application scenarios of the optoelectronic module.

In some possible implementations, the substrate has a second side wall on a side that is of the first region and that is away from the second region, the first side wall is disposed opposite to a first part of the second side wall, and the substrate has a third side wall located between the first side wall and the second side wall in the first region.

The substrate has a fourth side wall on a side that is of the second region and that is away from the first region, the fourth side wall is disposed opposite to a second part of the second side wall, and the substrate has a fifth side wall located between the fourth side wall and the first side wall in the second region.

The substrate has a sixth side wall, a first part of the sixth side wall is disposed opposite to the third side wall, and a second part of the sixth side wall is disposed opposite to the fifth side wall.

In embodiments of this disclosure, a surface of the substrate may be presented as an L-shaped substrate. In comparison with a rectangular substrate, the L-shaped substrate reduces the area of the chip, and reduces the area waste of the chip. More chips can be manufactured based on wafers with same areas, and a same quantity of chips uses a smaller wafer area, thereby reducing costs for manufacturing the chips.

In some possible implementations, in a plane parallel to the surface of the substrate, a size of the first side wall is greater than or equal to half of a size of the second side wall.

In embodiments of this disclosure, a size of the fourth side wall is less than or equal to half of the size of the second side wall, and two chips in a same wafer may be properly arranged and integrated into one rectangle, so that the more chips can be manufactured based on the wafers with the same areas.

In some possible implementations, on the first side of the substrate, an optical coupling interface is disposed on at least one of the first side wall and the fifth side wall, and the optical coupling interface is configured to connect to an optical fiber array unit.

In embodiments of this disclosure, in this special interface design, the size of the optoelectronic module is a larger value of the following two values: a size of the first side wall in the plane parallel to the surface of the substrate, and a sum of a size of the fourth side wall in the plane parallel to the surface of the substrate and a size of an optical fiber array. In comparison with the size of the optoelectronic module being a sum of a size of the chip and the size of the optical fiber array, a size of an optical fiber module is reduced.

In some possible implementations, projection space of the optical coupling interface on the substrate has a hollow region.

In embodiments of this disclosure, the hollow region can reduce light leakage at the optical coupling interface, and ensure strength of an optical signal.

In some possible implementations, the substrate further includes, in the first region, a seventh side wall and an eighth side wall that are connected between the fifth side wall and the first side wall; and/or the substrate further includes, in the second region, a ninth side wall and a tenth side wall that are connected between the fifth side wall and the first side wall.

In embodiments of this disclosure, based on the foregoing six side walls, only the seventh side wall and the eighth side wall may be added, or only the ninth side wall and the tenth side wall may be added, or the seventh side wall, the eighth side wall, the ninth side wall, and the tenth side wall may be added at the same time, so that the substrate is more diversified in shape.

In some possible implementations, the transmitter includes an electro-optic modulator, the electro-optic modulator includes a modulation waveguide and a modulation electrode pair on two sides of the modulation waveguide, and a material of the modulation electrode pair is transparent oxide.

In embodiments of this disclosure, the transparent oxide features a low optical loss and a high conductivity, and therefore, light utilization can be improved. In addition, because the transparent oxide features low light absorption, the transparent oxide may be closer to a modulation waveguide 121. This helps improve modulation efficiency and reduce the size of the chip.

In some possible implementations, a material of the modulation waveguide is silicon, lithium niobate, indium phosphide, or tantalum niobate.

In embodiments of this disclosure, electro-optic modulation efficiency of the lithium niobate, the indium phosphate, the tantalum niobate, or the like is high. This helps improve overall modulation efficiency of the chip and reduce the size of the chip.

In some possible implementations, projection space of the modulation waveguide on the substrate has a hollow region.

In embodiments of this disclosure, the hollow region can reduce light leakage at the modulation waveguide, and ensure strength of an optical signal.

In some possible implementations, the chip further includes: a transmission waveguide, where the transmission waveguide is connected to at least one of the receiver and the transmitter; and a dielectric layer, where the dielectric layer surrounds the transmission waveguide, the receiver, and the transmitter.

In embodiments of this disclosure, the transmission waveguide is used as an optical path, and can transmit an optical signal. This helps facilitate optical signal exchange between a plurality of components.

In some possible implementations, the transmission waveguide includes at least one of a first waveguide, a second waveguide, and a third waveguide, a material of the first waveguide is silicon, a material of the second waveguide is silicon nitride, and a material of the third waveguide is lithium niobate, indium phosphate, or tantalum niobate.

In embodiments of this disclosure, a plurality of transmission waveguides may be disposed, and waveguides of different materials are disposed at different locations based on features of the first waveguide, the second waveguide, and the third waveguide, to improve performance of the chip.

In some possible implementations, the chip further includes at least one of a first coupling structure, a second coupling structure, and a third coupling structure.

The first coupling structure includes a first coupling portion of the first waveguide and a second coupling portion of the second waveguide, the second coupling portion is located on a side that is of the first coupling portion and that is away from the substrate, and the first coupling portion and the second coupling portion are configured to implement optical coupling between the first waveguide and the second waveguide.

The second coupling structure includes a third coupling portion of the first waveguide and a fourth coupling portion of the third waveguide, the fourth coupling portion is located on a side that is of the third coupling portion and that is away from the substrate, and the third coupling portion and the fourth coupling portion are configured to implement optical coupling between the first waveguide and the third waveguide.

The third coupling structure includes a fifth coupling portion of the first waveguide, a sixth coupling portion of the second waveguide, and a seventh coupling portion of the third waveguide. The sixth coupling portion is located on a side that is of the fifth coupling portion and that is away from the substrate, the seventh coupling portion is located on a side that is of the sixth coupling portion and that is away from the substrate, and the third coupling structure is configured to implement optical coupling between the second waveguide and the third waveguide.

In embodiments of this disclosure, a plurality of coupling structures can enable signal transmission between different transmission waveguides, so that different technical requirements can be met based on the different waveguides.

In some possible implementations, the photodetector includes a light absorption structure, and a first doped structure and a second doped structure that are respectively located on two sides of the light absorption structure. A material of the light absorption structure is germanium, and doping types of the first doped structure and the second doped structure are opposite.

In embodiments of this disclosure, the photodetector may detect an optical signal, and form an electrical signal based on the detected optical signal. The doping types of the first doped structure and the second doped structure are opposite, and the first doped structure and the second doped structure are configured to separately transmit carriers with different electrical properties, to improve optical-electrical conversion efficiency.

In some possible implementations, the chip further includes: at least one of a balanced-unbalanced converter and a junction structure that are located on the first side of the substrate. The junction structure includes a third doped structure and a fourth doped structure, and doping types of the third doped structure and the fourth doped structure are opposite.

In embodiments of this disclosure, the at least one of the balanced-unbalanced converter and the junction structure may be further disposed, to further enrich functions integrated into the chip.

In some possible implementations, the transmitter includes at least one of an electro-optic modulator, a laser diode, and an optical amplifier, and the receiver includes at least one of a photodetector and an optical amplifier.

In embodiments of this disclosure, the transmitter may include the at least one of the electro-optic modulator, the laser diode (LD), and the optical amplifier, and the receiver may include the at least one of the photodetector (PD) and the optical amplifier, so that components with different functions are integrated, and the chip can be applied to more scenarios.

A second aspect of embodiments of this disclosure provides an optoelectronic module, including a housing, a circuit board, and the chip connected to the circuit board. The housing is configured to enclose the circuit board and the chip.

In some possible implementations, the optoelectronic module further includes: at least one of the optical fiber array unit connected to the optical coupling interface in the chip, a transimpedance amplifier connected to the chip, and a driver module connected to the chip.

A third aspect of embodiments of this disclosure provides a communication device, including: the optoelectronic module and a processing chip, where the optoelectronic module is connected to the processing chip.

Embodiments of this disclosure provide the chip, the optoelectronic module, and the optical communication device. The chip includes the substrate, and the transmitter and the receiver that are located on the first side of the substrate. The quantity of side walls of the substrate is greater than four, the transmitter is located in the first region of the substrate, the receiver is located in the second region of the substrate, the first region is adjacent to the second region, and the part of the substrate located in the first region has the first side wall on the side that is of the first region and that faces the second region. In other words, the shape of the substrate is not the rectangle. In addition, the part, of the first region, that is located on the side that is of the first side wall and that is away from the second region is the protruding part of the first region relative to the second region, so that the first region and the second region form the abnormal-shaped region. In this way, the first region and the second region may be respectively designed based on the area of the transmitter and the area of the receiver, and do not need to adapt to the regular rectangle of the chip. This reduces the area of the chip to some extent, reduces the area waste of the chip, and reduces the costs of the chip. This also correspondingly reduces the size of the optoelectronic module, and expands the application scenarios of the optoelectronic module.

### BRIEF DESCRIPTION OF DRAWINGS

To clearly understand specific implementations of this disclosure, the following briefly describes accompanying drawings used for describing the specific implementations of this disclosure. It is clear that the accompanying drawings show merely some embodiments of this disclosure.

FIG. 1 is a diagram of a layout of a current chip;

FIG. 2 is a diagram of dicing current chips;

FIG. 3 is a diagram of a structure of a current optoelectronic module;

FIG. 4 is a diagram of a structure of a chip according to an embodiment of this disclosure;

FIG. 5 is a sectional view of the chip in FIG. 4 in an AA direction;

FIG. 6 is a diagram of dicing chips according to an embodiment of this disclosure;

FIG. 7 is a diagram of a structure of another chip according to an embodiment of this disclosure;

FIG. 8 is a diagram of a structure of an optoelectronic module according to an embodiment of this disclosure;

FIG. 9 is a composition diagram of components in a chip according to an embodiment of this disclosure;

FIG. 10 is a diagram of a structure of an electro-optic modulator according to an embodiment of this disclosure;

FIG. 11 is a diagram of a structure of a laser diode according to an embodiment of this disclosure;

FIG. 12 is a diagram of a structure of a photodetector according to an embodiment of this disclosure;

FIG. 13 is a diagram of a junction structure according to an embodiment of this disclosure;

FIG. 14 is a diagram of a first coupling structure according to an embodiment of this disclosure;

FIG. 15 is a diagram of a second coupling structure according to an embodiment of this disclosure;

FIG. 16 is a diagram of a third coupling structure according to an embodiment of this disclosure;

FIG. 17 is a composition diagram of still another chip according to an embodiment of this disclosure;

FIG. 18 is a diagram of a structure of another optoelectronic module according to an embodiment of this disclosure; and

FIG. 19 is a diagram of a communication device according to an embodiment of this disclosure.

### DESCRIPTION OF EMBODIMENTS

Embodiments of this disclosure provide a chip, an optoelectronic module, and an optical communication device, to reduce an area waste of the chip and reduce costs of the chip.

In this disclosure, terms such as “first”, “second”, “third”, and “fourth” (if exists) in the specification, the claims, and the accompanying drawings are intended to distinguish between similar objects but do not necessarily indicate a specific order or sequence. It should be understood that data used in such a way is interchangeable in proper circumstances, so that embodiments described herein can be implemented in orders other than the order illustrated or described herein. Moreover, the terms “include”, “have”, and any other variants mean to cover a non-exclusive inclusion, for example, a process, method, system, product, or device that includes a list of steps or units is not necessarily limited to those steps or units, but may include other steps or units not expressly listed or inherent to such a process, method, product, or device.

This disclosure is described in detail with reference to a diagram. For ease of description, a sectional view of a component structure is partially enlarged not based on a general proportion, and the diagram is merely an example, and should not limit the protection scope of this disclosure. In addition, three-dimensional spatial dimensions of length, width, and depth need to be considered in the actual manufacturing.

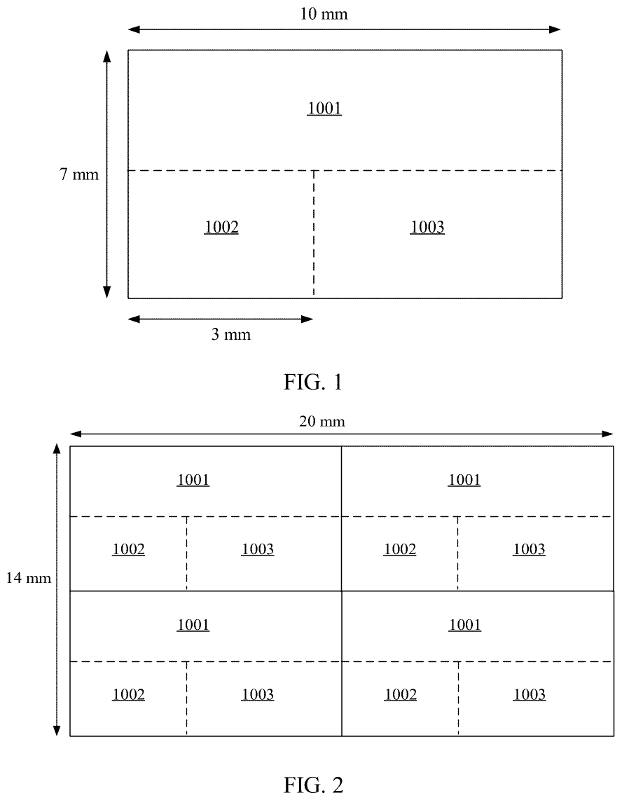

Currently, an optoelectronic chip may include at least one chip, and the chip may have a transmitter and a receiver. A shape of the chip is a rectangle. However, in an actual operation, sizes of the transmitter and the receiver are usually different. FIG. 1 is a diagram of a layout of a current chip. The chip includes a first region 1001, a second region 1002, and a third region 1003. The first region 1001 is used to dispose the transmitter, and the second region 1002 is used to dispose the receiver. For a size of the chip, a longest size of the transmitter and the receiver is used as a final layout width of the chip. As a result, an optional region (that is, the third region 1003) exists on the chip, and this region is not effectively used, causing an area waste of the chip and increasing costs of the chip.

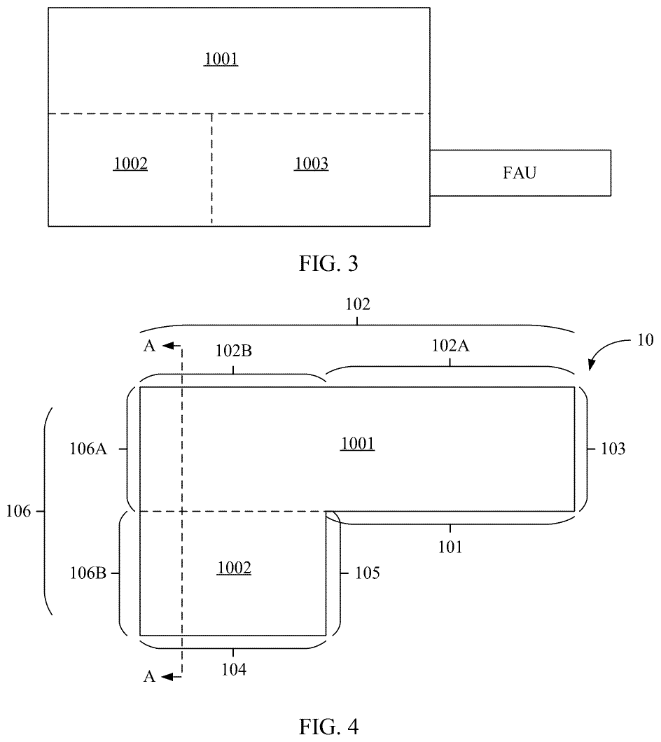

FIG. 2 is a diagram of dicing current chips. A plurality of rectangular chips are obtained through dicing. It can be seen from the figure that an area required by four chips is at least 14 millimeters (mm)*20 mm, and there is an area waste in a large quantity of third regions 1003. FIG. 3 is a diagram of a structure of a current optoelectronic module. The optoelectronic module includes a chip and an optical fiber array unit (FAU). A size of the optoelectronic module is a sum of a size of the chip and a size of the optical fiber array unit. When the size of the chip is large, the size of the optoelectronic module is also set to a large value. As a result, packaging costs of the optoelectronic module are high, and a large-size package restricts an application scenario of the chip, and is difficult to be applied to a scenario of a small-size module.

Based on the foregoing technical problem, embodiments of this disclosure provide a chip, an optoelectronic module, and an optical communication device. The chip includes a substrate, and a transmitter and a receiver that are located on a first side of the substrate. A quantity of side walls of the substrate is greater than four, the transmitter is located in a first region of the substrate, the receiver is located in a second region of the substrate, the first region is adjacent to the second region, and a part of the substrate located in the first region has a first side wall on a side that is of the first region and that faces the second region. In other words, a shape of the substrate is not a rectangle. In addition, a part, of the first region, that is located on a side that is of the first side wall and that is away from the second region is a protruding part of the first region relative to the second region, so that the first region and the second region form an abnormal-shaped region. In this way, the first region and the second region may be respectively designed based on an area of the transmitter and an area of the receiver, and do not need to adapt to a regular rectangle of the chip. This reduces an area of the chip to some extent, reduces an area waste of the chip, and reduces costs of the chip. This also correspondingly reduces a size of the optoelectronic module, and expands application scenarios of the optoelectronic module.

To make the foregoing objectives, features, and advantages of this disclosure clearer and more comprehensible, the following describes specific implementations of this disclosure in more detail with reference to accompanying drawings.

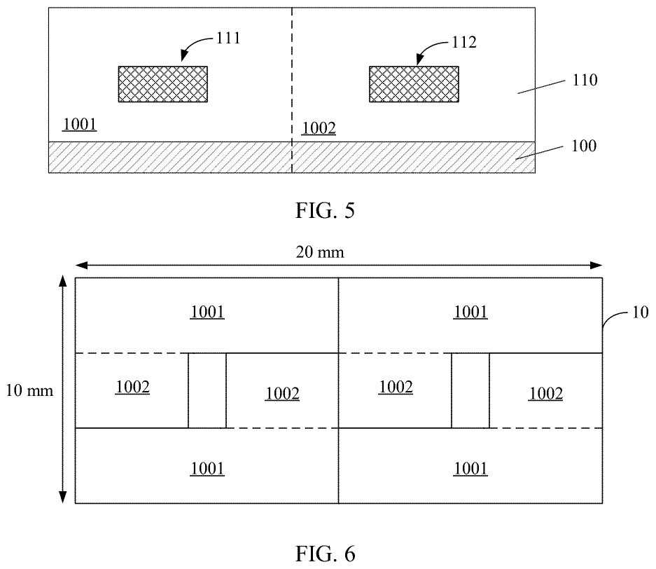

FIG. 4 and FIG. 5 are diagrams of a structure of a chip according to an embodiment of this disclosure. FIG. 5 is a sectional view of the chip in FIG. 4 in an AA direction. The chip 10 includes a substrate 100, and a transmitter 111 and a receiver 112 that are located on a first side of the substrate 100. The transmitter 111 is located in a first region 1001 of the substrate 100, the receiver 112 is located in a second region 1002 of the substrate 100, and the first region 1001 is adjacent to the second region 1002.

In this embodiment of this disclosure, the substrate 100 is configured to support a device on the substrate. The substrate 100 may be a semiconductor substrate, for example, may be a Si substrate, a Ge substrate, a SiGe substrate, a silicon-on-insulator (SOI) substrate, a germanium-on-insulator (GOI) substrate, or a silicon-germanium-on-insulator (SGOI) substrate. In another embodiment, the semiconductor substrate may alternatively be a substrate, for example, a GaAs substrate, an InP substrate, or a SiC substrate, of another element semiconductor or a compound semiconductor. In this embodiment of this disclosure, a material of the substrate 100 may be silicon.

For ease of description, in this embodiment of this disclosure, a side, of the chip 10, on which the transmitter 111 and the receiver 112 are disposed may be defined as the first side, and the first side may be used as “above”. To be specific, a direction from the substrate 100 to the transmitter 111 and the receiver 112 is referred to as a “top direction”, and a direction from the transmitter 111 and the receiver 112 to the substrate 100 is referred to as a “bottom direction”. Actually, such marking is for convenience and is irrelevant to a direction of gravity. When definition is made based on the direction of gravity, a location relationship between the substrate 100, the transmitter 111, and the receiver 112 is determined based on a placement condition of the chip including the substrate 100, the transmitter 111, and the receiver 112.

In this embodiment of this disclosure, the chip may be an integrated coherent transmitter receiver (ICTR) chip. As a photonic chip (PIC), the integrated coherent transmitter receiver chip may have an optical medium for transmitting an optical signal. When the material of the substrate 100 is the silicon, the photonic chip may be represented as Si-PIC. The transmitter 111 is configured to convert an electrical signal into an optical signal, and the receiver 112 is configured to convert an optical signal into an electrical signal, to implement conversion between the optical signal and the electrical signal via the transmitter 111 and the receiver 112. The transmitter 111 may be an integrated coherent transmitter (ICT), and the receiver 112 may be an integrated coherent receiver (ICR).

Sizes of the transmitter 111 and the receiver 112 are usually different. For a size of the chip, a longest size of the transmitter 111 and the receiver 112 may be used as a final layout width of the chip. As a result, an additional region exists on the chip, and this region is not effectively used, causing an area waste of the chip and increasing costs of the chip. For example, when the transmitter 111 includes an electro-optic modulator, a modulation voltage Vpi applied by a supported electrical chip to the electro-optic modulator is about 2 V to 3 V due to a length of the modulator, and the corresponding length of the modulator is about 8 mm to 10 mm. However, a length of the transmitter 111 is actually only about 3 mm. Refer to FIG. 1. There is a large area waste of the chip.

In view of this, in this embodiment of this disclosure, a quantity of side walls of the substrate 100 may be set to be greater than four, and a part of the substrate 100 located in the first region 1001 has a first side wall 101 on a side that is of the first region 1001 and that faces the second region 1002. In other words, a shape of the substrate 100 is not a rectangle. In addition, a part, of the first region 1001, that is located on a side that is of the first side wall 101 and that is away from the second region 1002 is a protruding part of the first region 1001 relative to the second region 1002, so that the first region 1001 and the second region 1002 form an abnormal-shaped region. In this way, the first region 1001 and the second region 1002 may be respectively designed based on an area of the transmitter 111 and an area of the receiver 112, and do not need to adapt to a regular rectangle of the chip 10, so that a layout of the first region 1001 and the second region 1002 is more reasonable. This reduces an area of the chip 10 to some extent, reduces an area waste of the chip 10, and reduces costs of the chip 10. This also correspondingly reduces a size of an optoelectronic module, and expands application scenarios of the optoelectronic module. The shape of the substrate 100 may be obtained through laser diode stealth dicing, and the substrate 100 may be any shape that meets the foregoing condition, to maximize utilization of the area of the chip 10 and reduce the costs of the chip 10.

It should be noted that the first region 1001 and the second region 1002 are defined for ease of describing the shape of the substrate 100. A boundary line (a horizontal dashed line in FIG. 5) between the first region 1001 and the second region 1002 is also added for ease of description. Actually, no boundary line is disposed between the first region 1001 and the second region 1002 on a surface and the inside of the chip 10. As a region for placing the transmitter 111, the first region 1001 may be a projection region of the transmitter 111 toward the substrate 100, or may be a regular or irregular region including the projection region. Similarly, as a region for placing the receiver 112, the second region 1002 may be a projection region of the receiver 112 toward the substrate 100, or may be a regular or irregular region including the projection region. The virtual boundary between the first region 1001 and the second region 1002 may be a straight line or a curve.

Specifically, a surface of the substrate 100 may be presented as an L shape. Refer to FIG. 4. The substrate 100 has a second side wall 102 on a side that is of the first region 1001 and that is away from the second region 1002, the first side wall 101 is disposed opposite to a first part 102A of the second side wall 102, and the substrate 100 has a third side wall 103 located between the first side wall 101 and the second side wall 102 in the first region 1001. In addition, the substrate 100 has a fourth side wall 104 on a side that is of the second region 1002 and that is away from the first region 1001, the fourth side wall 104 is disposed opposite to a second part 102B of the second side wall 102, and the substrate 100 has a fifth side wall 105 located between the fourth side wall 104 and the first side wall 101 in the second region 1002. The substrate 100 has a sixth side wall 106, a first part 106A of the sixth side wall 106 is disposed opposite to the third side wall 103, and a second part 106B of the sixth side wall 106 is disposed opposite to the fifth side wall 105. In an actual operation, the first side wall 101, the third side wall 103, the second side wall 102, the sixth side wall 106, the fourth side wall 104, and the fifth side wall 105 sequentially surround and are adjacent to each other, to form the L-shaped substrate 100.

In comparison with a rectangular substrate 100, the L-shaped substrate 100 reduces the area of the chip 10, and reduces the area waste of the chip 10. More chips 10 can be manufactured based on wafers with same areas, and a same quantity of chips 10 require a smaller wafer area, thereby reducing costs for manufacturing the chips 10. The L shape is used as an example, and the costs of the chip 10 may be reduced by about 50% to 60%. During specific implementation, in a plane parallel to the surface of the substrate 100, a length of the second side wall 102 is determined based on the length of the transmitter 111, a length of the third side wall 103 is determined based on a width of the transmitter 111, a length of the fourth side wall 104 is determined based on a length of the receiver 112, and a length of the fifth side wall 105 is determined based on a width of the receiver 112. When a difference between the length of the transmitter 111 and the length of the receiver 112 is large, in the plane parallel to the surface of the substrate 100, a size of the first side wall 101 may be set to be greater than or equal to half of a size of the second side wall 102. To be specific, a size of the fourth side wall 104 is less than or equal to half of the size of the second side wall 102, and two chips 10 in a same wafer may be properly arranged and integrated into one rectangle, so that the more chips 10 can be manufactured based on the wafers with the same areas.

FIG. 6 is a diagram of dicing chips according to an embodiment of this disclosure. Two chips 10 are interconnected into one rectangle. In this way, an area required by four chips 10 is at least 10 mm*20 mm. In comparison with the area required by the four chips in FIG. 2 being at least 14 mm*20 mm, a same quantity of chips require a smaller area.

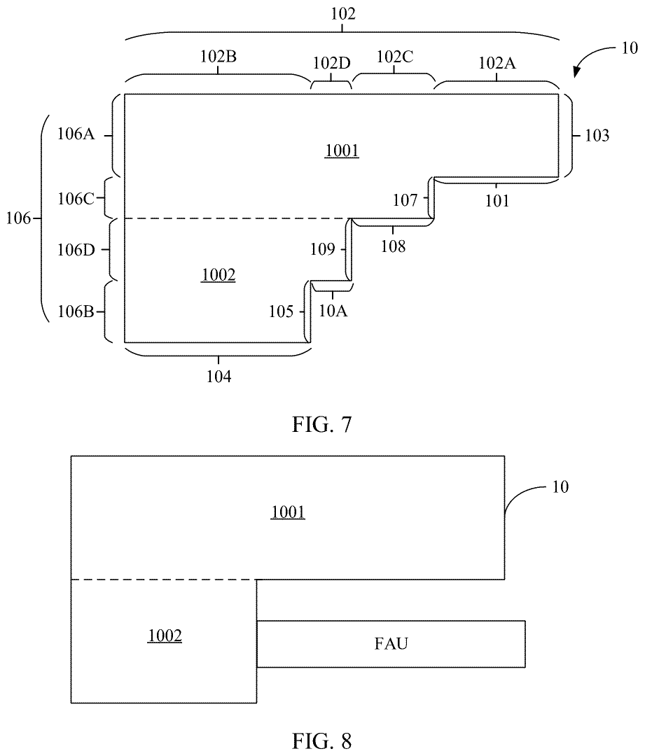

Specifically, the surface of the substrate 100 may be presented as an irregular shape, and a plurality of side walls form a stepped shape. FIG. 7 is a diagram of a structure of another chip according to an embodiment of this disclosure. In the first region 1001, the substrate 100 may further include a seventh side wall 107 and an eighth side wall 108 that are connected between the fifth side wall 105 and the first side wall 101. The seventh side wall 107 directly faces a third part 106C of the sixth side wall 106, and the eighth side wall 108 directly faces a third part 102C of the second side wall 102, so that the substrate 100 is more diversified in shape. In this embodiment of this disclosure, in the second region 1002, the substrate 100 further includes a ninth side wall 109 and a tenth side wall 10A that are connected between the fifth side wall 105 and the first side wall 101. The ninth side wall directly faces a fourth part 106D of the sixth side wall 106, and the tenth side wall directly faces a fourth part 102D of the second side wall 102. In an actual operation, based on the foregoing six side walls, only the seventh side wall 107 and the eighth side wall 108 may be added, or only the ninth side wall 109 and the tenth side wall 10A may be added, or the seventh side wall 107, the eighth side wall 108, the ninth side wall 109, and the tenth side wall 10A may be added at the same time. In this case, the third side wall 103, the first side wall 101, the seventh side wall 107, the eighth side wall 108, the ninth side wall 109, the tenth side wall 10A, and the fifth side wall 105 are sequentially adjacent to each other.

In this embodiment of this disclosure, the chip 10 further has an optical coupling interface that allows receiving an optical signal from an optical fiber and transmitting an optical signal to an optical fiber. The optical coupling interface has a waveguide configured to couple to the optical fiber to transmit the optical signal. In a multi-channel optoelectronic module, the chip 10 may have a plurality of waveguides, and the plurality of waveguides form a waveguide array. The optical coupling interface is configured to connect to an optical fiber array unit. The optical fiber array unit is configured to fasten an optical fiber array (FA). The optical fiber array is coupled to the waveguide array, so that the chip 10 can receive the optical signal from the optical fiber array or transmit the optical signal to the optical fiber array. A plurality of optical fibers in the optical fiber array may be single-mode optical fibers or other optical fibers. The optical fiber array may be fastened, to have a determined relative location, and a component configured to fasten the optical fiber array and align the optical fiber array to the chip 10 is referred to as the optical fiber array unit. A coupling manner of the optical fiber array and the waveguide array may be using an edge coupler (EC). The optical fiber array is coupled to an edge of the chip 10. The edge coupler has a small loss, and is widely concerned.

Specifically, the optical coupling interface may be disposed on at least one of the first side wall 101 and the fifth side wall 105. In this special interface design, a size of the optoelectronic module is a larger value of the following two values: a size of the first side wall 101 in the plane parallel to the surface of the substrate 100, and a sum of a size of the fourth side wall 104 in the plane parallel to the surface of the substrate 100 and a size of the optical fiber array. In this way, in comparison with the size of the optoelectronic module being a sum of a size of the chip 10 and the size of the optical fiber array, a size of an optical fiber module is reduced. In addition, projection space of the optical coupling interface on the substrate 100 has a hollow region. In this way, the hollow region can reduce light leakage at the optical coupling interface, and ensure strength of an optical signal.

FIG. 8 is a diagram of a structure of an optoelectronic module according to an embodiment of this disclosure. An optical coupling interface is disposed on the fifth side wall 105, an optical fiber array unit is disposed in a region between the first side wall 101 and the fifth side wall 105, and a sum of a size of the fourth side wall 104 in a plane parallel to a surface of the substrate 100 and a size of the optical fiber array is slightly greater than a size of the first side wall 101 in the plane parallel to the surface of the substrate 100. In comparison with the design in FIG. 3, an overall size of the optoelectronic module is reduced. In an actual operation, when the optical coupling interface is disposed on the fifth side wall 105, the size of the optoelectronic module may be reduced by about 25%. Application scenarios of the chip 10 are expanded.

In this embodiment of this disclosure, the transmitter 111 may include at least one of an electro-optic modulator, a LD, and an optical amplifier, and the receiver 112 may include at least one of a PD and an optical amplifier. Quantities of electro-optic modulators, laser diodes, optical amplifiers, and photodetectors may be set based on an actual case, so that components with different functions are integrated, and the chip 10 can be applied to more scenarios. The transmitter 111 and the receiver 112 may be disposed at a dielectric layer 110. The dielectric layer 110 isolates the transmitter 111 and the receiver 112, and protects the transmitter 111 and the receiver 112. A material of the dielectric layer 110 may be, for example, silicon oxide. The optical amplifier may be a semiconductor optical amplifier (SOA). The chip 10 including the high-speed electro-optic modulator and the high-speed photodetector is widely used in a large-capacity and long-distance coherent communication system as a core interface for conversion from an electrical domain to an optical domain and from an optical domain to an electrical domain in an optical network. A form of the chip 10 directly affects a rate, a size, costs, power consumption, and the like of the optoelectronic module. When the size of the chip 10 is large, the optoelectronic module usually has a low rate, a large size, high costs, and high power consumption.

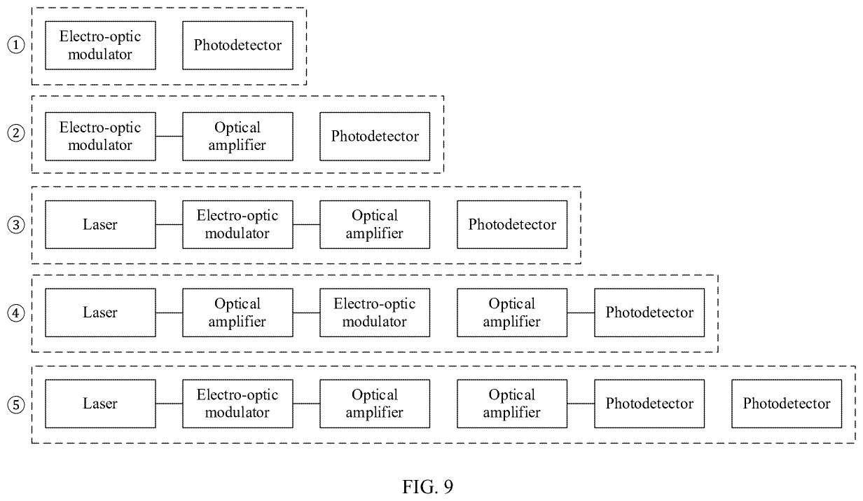

The chip 10 may include a plurality of building block (BB) units. Types and quantities of laser diodes, electro-optic modulators, SOAs, and PDs, and various organizational forms are not limited in embodiments of this disclosure. FIG. 9 is a composition diagram of components in the chip 10 according to an embodiment of this disclosure. In a first example \textcircled{1}, the chip 10 includes an electro-optic modulator and a photodetector. In a second example \textcircled{2}, the chip 10 includes an electro-optic modulator, an optical amplifier, and a photodetector, where the electro-optic modulator is connected to the optical amplifier. In a third example \textcircled{3}, the chip 10 includes a laser diode, an electro-optic modulator, and an optical amplifier that are sequentially connected, and further includes a photodetector. In a fourth example \textcircled{4}, the chip 10 includes a laser diode, an optical amplifier, and an electro-optic modulator that are sequentially connected, and further includes an optical amplifier and a photodetector that are sequentially connected. In a fifth example \textcircled{5}, the chip 10 includes a laser diode, an electro-optic modulator, and an optical amplifier that are sequentially connected, further includes an optical amplifier and a photodetector that are sequentially connected, and further includes an additional photodetector.

The electro-optic modulator may include a modulation waveguide 121 and a modulation electrode pair 122 on two sides of the modulation waveguide 121. The modulation electrode pair 122 provides a modulation electric field when a voltage is applied to the modulation electrode pair 122. The modulation electric field may affect an optical feature of the modulation waveguide 121, to modulate an optical signal of the modulation waveguide 121. A material of the modulation waveguide 121 may be silicon, lithium niobate (LN), indium phosphide (InP), tantalum niobate, or the like. Modulation waveguides 121 of different materials may enable the electro-optic modulator to have different electro-optic modulation efficiency. For example, electro-optic modulation efficiency of the lithium niobate, the indium phosphide, or the tantalum niobate is higher than electro-optic modulation efficiency of the silicon. This helps improve overall modulation efficiency of the chip 10 and reduce a size of the chip 10. When the modulation waveguide 121 is made of a lithium niobate material, the electro-optic modulator may be referred to as a thin-film lithium niobate (TFLN) modulator. The thin film lithium niobate modulator features high bandwidth and a small size, operates without cooling, and may be applied to a scenario like coherent communication at baud rates of 130 GBaud or higher.

The modulation electrode pair 122 may be led out to a surface of the dielectric layer 110 via inter-layer interconnection structures 123, and the inter-layer interconnection structure 123 may include a conductive pillar, or may include a conductive pillar and a conductive pad. There may be a plurality of conductive pillars and a plurality of conductive pads. The conductive pillars may be disposed between conductive pads at adjacent layers. The conductive pillars are disposed in through holes that extend longitudinally at the dielectric layer 110. The plurality of conductive pads may longitudinally separate the through holes that penetrate the dielectric layer 110 into a plurality of through holes, thereby reducing depths of the through holes, reducing depth-width ratios of the through holes, reducing etching difficulty, and improving reliability of the inter-layer interconnection structure 123. In addition, projection space of the modulation waveguide 121 on the substrate 100 has a hollow region. In this way, the hollow region can reduce light leakage at the modulation waveguide 121, and ensure strength of an optical signal.

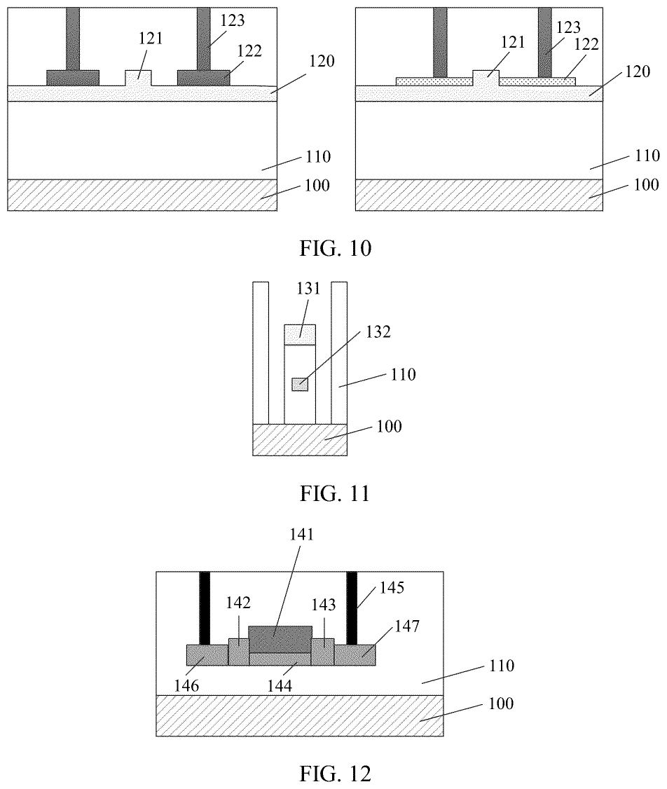

FIG. 10 is a diagram of a structure of an electro-optic modulator according to an embodiment of this disclosure. A material of the modulation waveguide 121 is lithium niobate, and is a protruding fin structure on a lithium niobate film layer 120. The modulation electrode pair 122 is located on the lithium niobate film layer 120, and is separately located on two sides of the modulation waveguide 121. The dielectric layer 110 is disposed above the modulation waveguide 121 and the modulation electrode pair 122, and the modulation electrode pair 122 is led out to a surface of the dielectric layer 110 via inter-layer interconnection structures. In FIG. 10A, a material of the modulation electrode pair 122 is metal, for example, may be gold. In FIG. 10B, a material of the modulation electrode pair 122 is transparent oxide (TCO), for example, ITO or IGZO. The transparent oxide features a low light loss and a high conductivity, and therefore, light utilization can be improved. In addition, because the transparent oxide features low light absorption, the transparent oxide may be closer to the modulation waveguide 121. This helps improve modulation efficiency and reduce a size of the chip 10.

The laser diode is configured to generate an optical carrier. In this way, based on the electro-optic modulator, an electrical signal on the modulation electrode pair 122 may be modulated to the optical carrier in the modulation waveguide 121, to form an optical signal. FIG. 11 is a diagram of a structure of a laser diode according to an embodiment of this disclosure. The laser diode includes a light emitting structure 131, and a material of the light emitting structure 131 includes a group III-V compound like gallium nitride and indium phosphide. The laser diode further includes the waveguide (WG) 132. The waveguide 132 is configured to propagate an optical carrier generated by the laser diode to the outside of the laser diode. A material of the waveguide 132 may be silicon nitride (SiN). The laser diode may be disposed at the dielectric layer 110, and has a specific distance from the dielectric layer 110, to reduce light absorption of the dielectric layer 110.

A photodetector may detect an optical signal, and form an electrical signal based on the detected optical signal. FIG. 12 is a diagram of a structure of a photodetector according to an embodiment of this disclosure. The photodetector includes a light absorption structure 141. The light absorption structure 141 may generate a carrier under light irradiation, and a material of the light absorption structure 141 may include germanium and the like. The photodetector may further include a first doped structure 142 and a second doped structure 143 that are respectively located on two sides of the light absorption structure 141. Doping types of the first doped structure 142 and the second doped structure 143 are opposite, and the first doped structure 142 and the second doped structure 143 are configured to separately transmit carriers with different electrical properties, to improve optical-electrical conversion efficiency.

The photodetector 14 may be led out to a surface of the dielectric layer 110 via an inter-layer interconnection structure 145, to lead the generated electrical signal to the outside of the dielectric layer 110. The inter-layer interconnection structure 145 may include a conductive pillar, or may include a conductive pillar and a conductive pad. There may be a plurality of conductive pillars and a plurality of conductive pads. The conductive pillars may be disposed between conductive pads at adjacent layers. The conductive pillars are disposed in through holes that extend longitudinally at the dielectric layer 110. The plurality of conductive pads may longitudinally separate the through holes that penetrate the dielectric layer 110 into a plurality of through holes, thereby reducing depths of the through holes, reducing depth-width ratios of the through holes, reducing etching difficulty, and improving reliability of the inter-layer interconnection structure 145.

Specifically, the first doped structure 142 and the second doped structure 143 may be respectively connected to different inter-layer interconnection structures 145. In addition, a fifth doped structure 146 may be further disposed between the first doped structure 142 and the inter-layer interconnection structure 145. The fifth doped structure 146 has a same doping type as the first doped structure 142, and has doping concentration higher than that of the first doped structure 142. A sixth doped structure 147 may be further disposed between the second doped structure 143 and the inter-layer interconnection structure. The sixth doped structure 147 has a same doping type as the second doped structure 143, and has doping concentration higher than that of the second doped structure 143. An intrinsic layer 144 may be further disposed between the first doped structure 142 and the second doped structure 143. One side of the intrinsic layer 144 is in contact with the first doped structure 142, and the other side is in contact with the second doped structure 143, so that the first doped structure 142, the intrinsic layer 144, and the second doped structure 143 form a p-i-n structure. The intrinsic layer 144 and the light absorption structure 141 are stacked, one side of the light absorption structure 141 is in contact with the first doped structure 142, and the other side is in contact with the second doped structure 143, so that the intrinsic layer 144 and the light absorption structure 141 are both located between the first doped structure 142 and the second doped structure 143. The first doped structure 142, the second doped structure 143, the fifth doped structure 146, the sixth doped structure 147, and the intrinsic layer 144 may have same intrinsic materials, for example, all of which are silicon. The first doped structure 142 and the fifth doped structure 146 may have same doping elements. The second doped structure 143 and the sixth doped structure 147 may have same doping elements. The fifth doped structure 146 and the sixth doped structure 147 each are in good contact with the photodetector, and are in good contact with inter-layer interconnection structures 145, thereby reducing a contact loss of an electrical signal.

In the field of semiconductor devices, a doping element may be doped into a semiconductor, and types of the doping element may be classified into a P−type (hole concentration, positive) and an N−type (electron concentration, negative). The type of the doping element may also be referred to as a doping type. For example, a P−type doping element may be doped into the semiconductor to obtain a P−type semiconductor, so that the P−type semiconductor mainly performs hole conduction. Alternatively, an N−type doping element is doped into the semiconductor to obtain an N−type semiconductor, so that the N−type semiconductor mainly performs electron conduction. A material of a doped semiconductor is used as an intrinsic material. Concentration of doping elements in the doped semiconductor is used as doping concentration, and may be represented based on a ratio of the doping elements to a semiconductor element, or may be represented based on a quantity of atoms of the doping element per unit volume. The P−type doping element may be a group III element, for example, boron and indium, and the N−type element may be a group V element, for example, nitrogen and phosphorus.

Doping on the semiconductor may be classified into light doping and heavy doping based on the concentration of the doping elements in the doped semiconductor, and correspondingly, the doped semiconductor is a light doped semiconductor or a heavy doped semiconductor. Light doping may be performed on the first doped structure 142 and the second doped structure 143, and heavy doping may be performed on the fifth doped structure 146 and the sixth doped structure 147.

The light doping means that a small quantity of doping elements are doped, and concentration of the doping elements in the doped semiconductor is low. For example, a ratio of an atom quantity of the doping elements to an atom quantity of the semiconductor element is about one part per billion. For example, performing light doping on the semiconductor based on P−type doping elements may be represented as low hole concentration (P−type) doping, to obtain a P−type semiconductor; and performing light doping on the semiconductor based on N−type doping elements may be represented as low electron concentration (N−type) doping, to obtain an N−type semiconductor. The heavy doping means that a large quantity of doping elements are doped, and concentration of the doping elements in the doped semiconductor is high. For example, a ratio of an atom quantity of the doping elements to an atom quantity of the semiconductor element is about one part per thousand. For example, performing heavy doping on the semiconductor based on P−type doping elements may be represented as high hole concentration (P+type) doping, to obtain a P+type semiconductor; and performing heavy doping on the semiconductor based on N−type doping elements may be represented as high electron concentration (N+type) doping, to obtain an N+type semiconductor.

An optical amplifier is configured to amplify an optical signal. An optical amplifier in the transmitter 111 may amplify an optical carrier generated by the laser diode, or amplify a modulated optical signal. An optical amplifier in the receiver 112 may amplify a received optical signal, and the amplified optical signal is detected by the photodetector. A material of the optical amplifier includes the group III-V compound, for example, the gallium nitride.

In this embodiment of this disclosure, the chip 10 may further include at least one of a balanced-unbalanced converter and a junction structure that are located on a first side of the substrate 100. The balanced-unbalanced converter is also referred to as a balun structure, and includes at least one input end and at least one output end. A quantity of input ends is different from a quantity of output ends, to implement conversion of an electrical signal.

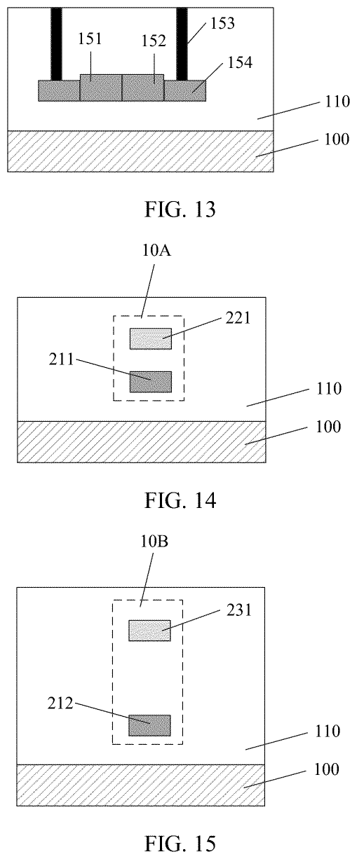

FIG. 13 is a diagram of a junction structure according to an embodiment of this disclosure. The junction structure includes a third doped structure 151 and a fourth doped structure 152. Doping types of the third doped structure 151 and the fourth doped structure 152 are opposite. The third doped structure 151 and the fourth doped structure 152 form a PN junction, and the junction structure may be used as a modulator, an optical amplifier, a switch, or the like. The junction structure may be led out to a surface of the dielectric layer 110 via an inter-layer interconnection layer 153, and a doped structure 154 may be disposed between the junction structure and the inter-layer interconnection layer 153.

The chip 10 may further include a polarization splitter-rotator (PSR) located on a first side of the substrate 100. The polarization splitter-rotator includes an input end, a first output end for a TM channel, and a second output end for a TE channel. An input light beam input to the input end includes N channel optical signals having two orthogonal polarizations such as a TE polarization and a TM polarization. The input light beam may be separated based on the polarizations, so that the optical signals are divided into light in different polarization states. The polarization splitter-rotator further includes a rotator, configured to rotate a polarization state of light. The polarization splitter-rotator may be enclosed by the dielectric layer 110, and a refractive index of the polarization splitter-rotator is greater than a refractive index of the dielectric layer 110, and a material of the polarization splitter-rotator may be SiN.

In this embodiment of this disclosure, the chip 10 further includes a transmission waveguide located on the first side of the substrate 100. The transmission waveguide is connected to at least one of the receiver 112 and the transmitter 111. The dielectric layer 110 encloses the transmission waveguide, the receiver 112, and the transmitter 111. The refractive index of the dielectric layer 110 is less than a refractive index of the transmission waveguide. As an optical path, the transmission waveguide is used as an optical path, and can transmit an optical signal. This helps facilitate optical signal exchange between a plurality of components. For example, the transmission waveguide transmits an optical signal to the receiver 112, or may transmit an optical signal sent by the transmitter 111. Therefore, the transmission waveguide may be disposed in the second region 1002 in which the receiver 112 is located, or may be disposed in the first region 1001 in which the transmitter 111 is located.

The transmission waveguide may have a single material, or may have a plurality of materials. The transmission waveguide includes at least one of a first waveguide, a second waveguide, and a third waveguide, a material of the first waveguide is silicon, a material of the second waveguide is silicon nitride, and a material of the third waveguide is lithium niobate, indium phosphate, or tantalum niobate. The first waveguide and the third waveguide have electro-optic effect, and the electro-optic effect may be consistent with that of the modulation waveguide 121 in an electro-optic modulator. When materials of the modulation waveguide 121 and the first waveguide are consistent, the modulation waveguide 121 and the first waveguide may be disposed at a same layer. When materials of the modulation waveguide 121 and the second waveguide are consistent, the modulation waveguide 121 and the second waveguide may be disposed at a same layer.

In addition, a waveguide in a laser diode and a transmission waveguide of a material consistent with that of the waveguide in the laser diode are located at a same layer. For example, if a material of the waveguide 132 in the laser diode is silicon nitride, the waveguide 132 in the laser diode and the second waveguide are located at a same layer. When a material of a doped structure (that is, at least one of the first doped structure 142, the second doped structure 143, the fifth doped structure 146, and the sixth doped structure 147) in the photodetector is the silicon, the waveguide in the laser diode and the first waveguide may be located at a same layer. When a material of a doped structure (at least one of the third doped structure 151 and the fourth doped structure 152) in the junction structure is the silicon, the waveguide in the laser diode and the first waveguide 21 may be located at a same layer. In this way, different structures of a same material are disposed at a same layer, and a same process may be used to form these structures, thereby simplifying a manufacturing process and reducing manufacturing costs.

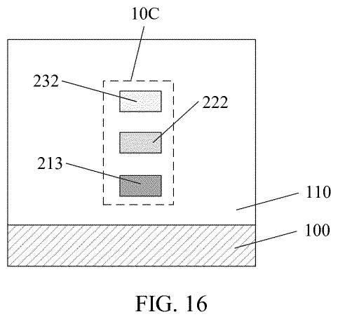

In this embodiment of this disclosure, the chip 10 further includes at least one of a first coupling structure 10A, a second coupling structure 10B, and a third coupling structure 10C. FIG. 14 is a diagram of a first coupling structure according to an embodiment of this disclosure. FIG. 15 is a diagram of a second coupling structure according to an embodiment of this disclosure. FIG. 16 is a diagram of a third coupling structure according to an embodiment of this disclosure. A plurality of coupling structures can enable signal transmission between different transmission waveguides, so that different technical requirements can be met based on the different waveguides. When a first waveguide and a second waveguide exist in the chip 10, optical coupling between the first waveguide and the second waveguide may be implemented via the first coupling structure 10A. A transmission loss of the second waveguide is less than a transmission loss of the first waveguide 21. Therefore, transmission waveguides of different materials may be arranged at different locations based on features of the first waveguide and the second waveguide, thereby improving performance of the chip 10. When the second waveguide and a third waveguide exist in the chip 10, optical coupling between the first waveguide and the third waveguide may be implemented via the second coupling structure 10B. The second waveguide has a small transmission loss and low manufacturing costs, and the third waveguide has an electro-optic modulation feature. Transmission waveguides of different materials may be arranged at different locations based on features of the second waveguide and the third waveguide, thereby improving the performance of the chip 10. When the first waveguide, the second waveguide, and the third waveguide exist in the chip 10, optical coupling between the second waveguide and the third waveguide may be implemented via the third coupling structure 10C. The first waveguide has low manufacturing costs, the second waveguide has the small transmission loss, and the third waveguide has high electro-optic modulation efficiency. Therefore, transmission waveguides of different materials may be disposed at different locations based on features of different materials, thereby improving the performance of the chip 10. The foregoing optical coupling may be evanescent coupling (EVC).

The first coupling structure 10A includes a first coupling portion 211 of the first waveguide and a second coupling portion 221 of the second waveguide. The second coupling portion 221 is located on a side that is of the first coupling portion 211 and that is away from the substrate 100. For example, when the first waveguide and the second waveguide are located above the substrate 100, the second coupling portion 221 is located above the first coupling portion 211. The second coupling structure 10B includes a third coupling portion 212 of the first waveguide and a fourth coupling portion 231 of the third waveguide. The fourth coupling portion 231 is located on a side that is of the third coupling portion 212 and that is away from the substrate 100. For example, when the first waveguide and the third waveguide are located above the substrate 100, the fourth coupling portion 231 is located above the third coupling portion 212. The third coupling structure 10C includes a fifth coupling portion 213 of the first waveguide, a sixth coupling portion 222 of the second waveguide, and a seventh coupling portion 232 of the third waveguide. The sixth coupling portion 222 is located on a side that is of the fifth coupling portion 213 and that is away from the substrate 100, and the seventh coupling portion 232 is located on a side that is of the sixth coupling portion 222 and that is away from the substrate 100. For example, when the first waveguide, the second waveguide, and the third waveguide are located above the substrate 100, the sixth coupling portion 222 is located above the fifth coupling portion 213, and the seventh coupling portion 232 is located above the sixth coupling portion 222.

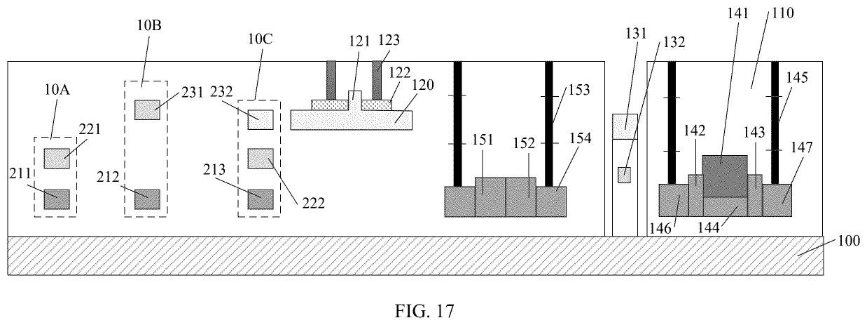

FIG. 17 is a composition diagram of still another chip according to an embodiment of this disclosure. The chip includes the first coupling structure 10A, the second coupling structure 10B, and the third coupling structure 10C, and further includes an electro-optic modulator, a junction structure, a laser diode, and a photodetector detector. These components are described in the foregoing figures. Details are not described herein again.

In this embodiment of this disclosure, the transmitter 111 and the receiver 112 may be disposed on the single chip 10, including a combination of a plurality of components and a combination of a plurality of transmission waveguides, so that the single chip 10 can implement hybrid integration of more functions. The high-rate, high-integration, and low-cost optical chip 10 with better performance and integrated with a transmitter and a receiver can be implemented. The chip 10 integrated with a plurality of transmitters and a plurality of receivers features high bandwidth, small-size non-hermetic encapsulation, and high integration, and operates without cooling. In comparison with an optical chip of other approaches, the chip 10 significantly improves modulator bandwidth and impedance, integrates a high-performance passive structure, and reduces a size, costs, and power consumption of a transmit end of an optical module, thereby providing an important solution for evolution of a future optical module. The chip 10 may be applied to a line-side solution of a coherent ICTR optical chip 10 like a 400 gigabits per second (Gbps)+ module (140 Gbps generation) or an 800 Gbps+ module (200 Gbps/240 Gbps generation), and may also be applied to a client-side solution of an 800 Gbps+ module.

Embodiments of this disclosure provide the chip. The chip includes the substrate, and the transmitter and the receiver that are located on the first side of the substrate. The quantity of side walls of the substrate is greater than four, the transmitter is located in the first region of the substrate, the receiver is located in the second region of the substrate, the first region is adjacent to the second region, and the part of the substrate located in the first region has the first side wall on the side that is of the first region and that faces the second region. In other words, the shape of the substrate is not the rectangle. In addition, the part, of the first region, that is located on the side that is of the first side wall and that is away from the second region is the protruding part of the first region relative to the second region, so that the first region and the second region form the abnormal-shaped region. In this way, the first region and the second region may be respectively designed based on the area of the transmitter and the area of the receiver, and do not need to adapt to the regular rectangle of the chip. This reduces the area of the chip to some extent, reduces the area waste of the chip, and reduces the costs of the chip. This also correspondingly reduces the size of the optoelectronic module, and expands the application scenarios of the optoelectronic module.

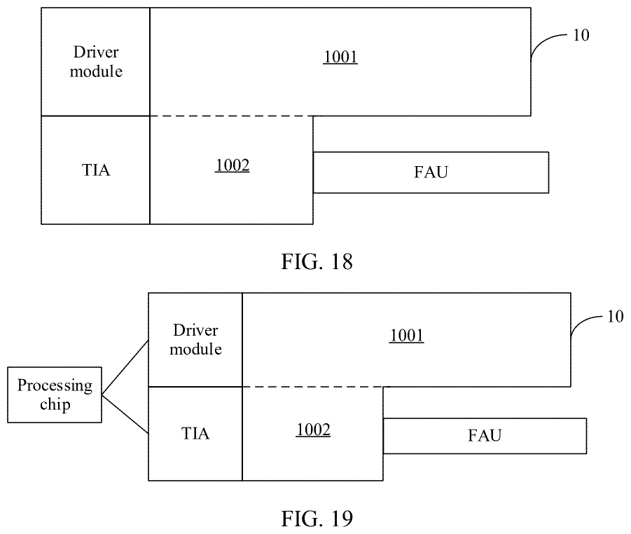

Based on the chip provided in the foregoing embodiments, an embodiment of this disclosure provides an optoelectronic module. FIG. 18 is a diagram of a structure of an optoelectronic module according to an embodiment of this disclosure. The optoelectronic module includes a housing, a circuit board, and the chip 10 connected to the circuit board. The housing is configured to enclose the circuit board and the chip 10. The optoelectronic module may be a pluggable module (faceplate-pluggable module), a co-packaged-optics module (co-packaged-optics module), or the like. The co-packaged-optics module is a non-pluggable module. The optoelectronic module and a switch chip form an optical switch. The optical switch can be used for data exchange between servers at different layers in a large-scale data center, and can improve bandwidth and significantly reduce additional power consumption caused by cable routing on a switching network.

Refer to FIG. 8 and FIG. 18. FIG. 18 is a diagram of a structure of another optoelectronic module according to an embodiment of this disclosure. The optoelectronic module may further include at least one of an optical fiber array unit (FAU) connected to an optical coupling interface of a chip, a trans-impedance amplifier (TIA) connected to the chip, and a driver (driver) module connected to the chip. The optical fiber array unit is configured to fasten an optical fiber array. A transmitter in the chip is configured to connect to an output optical fiber, so that an optical signal generated by the transmitter is output to the outside of the chip through the output optical fiber. A receiver in the chip is configured to connect to an input optical fiber, so that an optical signal that passes through the input optical fiber can be received by the receiver and converted into an electrical signal. The driver module is connected to an electro-optic modulator, and is configured to provide a modulation signal. The modulation signal is applied to a modulation electrode pair, to modulate an optical carrier in a modulation waveguide based on the modulation signal, and load the modulation signal used as an electrical signal to the optical carrier. The transimpedance amplifier is connected to a photodetector, and is configured to amplify an electrical signal generated by the photodetector.

Based on the chip and the optoelectronic module provided in the foregoing embodiments, an embodiment of this disclosure further provides a communication device. FIG. 19 is a diagram of a structure of a communication device according to an embodiment of this disclosure. The communication device includes the foregoing optoelectronic module, and the optoelectronic module includes the foregoing chip 10. The communication device further includes a processing chip, and the optoelectronic module is connected to the processing chip. The communication device may be a switch, a router, a server, or the like.

The processing chip may be an optical digital signal processing (oDSP) chip. The processing chip may be connected to a driver module, and is configured to control the driver module to generate a modulation signal. The processing chip may be connected to a transimpedance amplifier, and is configured to control the trans-impedance amplifier to amplify an electrical signal and process the amplified electrical signal.

Embodiments in this specification are all described in a progressive manner, for same or similar parts in embodiments, reference may be made to these embodiments, and each embodiment focuses on a difference from other embodiments.

The foregoing provides specific implementations of this disclosure. It should be understood that the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this disclosure.

1. A chip comprising:
a substrate, comprising:
a first side;
a first region;
a second region adjacent to the first region; and
at least five side walls comprising a first side wall located in the first region and facing the second region;
a transmitter located on the first side and in the first region; and
a receiver located on the first side and in the second region.

2. The chip of claim 1, wherein the at least five side walls further comprise:
a second side wall located in the first region and away from the second region, wherein the second side wall comprises:
a first part located opposite from the first side wall; and
a second part;
a third side wall located between the first side wall and the second side wall and in the first region;
a fourth side wall located in the second region, away from the first region, and located opposite from the second part;
a fifth side wall located between the fourth side wall and the first side wall and in the second region; and
a sixth side wall comprising:
a third part located opposite from the third side wall; and
a fourth part located opposite from the fifth side wall.

3. The chip of claim 2, wherein the substrate further comprises a surface, and wherein in a plane parallel to the surface, a first size of the first side wall is greater than or equal to half of a second size of the second side wall.

4. The chip of claim 2, further comprising an optical coupling interface located on the first side and on at least one of the first side wall or the fifth side wall, wherein the optical coupling interface is configured to connect to an optical fiber array.

5. The chip of claim 4, wherein a space on the substrate corresponding to a projection of the optical coupling interface onto the substrate comprises a hollow region.

6. The chip of claim 2, wherein the at least five side walls further comprise:
a seventh side wall and an eighth side wall that are connected in the first region between the fifth side wall and the first side wall; or
a ninth side wall and a tenth side wall that are connected in the second region between the fifth side wall and the first side wall.

7. The chip of claim 1, wherein the transmitter comprises an electro-optic modulator, comprising:
a modulation waveguide; and
a modulation electrode pair on two sides of the modulation waveguide, and wherein a first material of the modulation electrode pair is transparent oxide.

8. The chip of claim 7, wherein a second material of the modulation waveguide is silicon, lithium niobate, indium phosphide, or tantalum niobate.

9. The chip of claim 7, wherein a space on the substrate corresponding to a projection of the modulation waveguide onto the substrate comprises a hollow region.

10. The chip of claim 1, further comprising:
a transmission waveguide, connected to at least one of the receiver or the transmitter; and
a dielectric layer, surrounding the transmission waveguide, the receiver, and the transmitter.

11. The chip of claim 10, wherein the transmission waveguide comprises at least one of a first waveguide, a second waveguide, or a third waveguide, wherein a first material of the first waveguide is silicon, wherein a second material of the second waveguide is silicon nitride, and wherein a third material of the third waveguide is lithium niobate, indium phosphate, or tantalum niobate.

12. The chip of claim 11, further comprising at least one of:
a first coupling structure comprising:
a first coupling portion of the first waveguide; and
a second coupling portion of the second waveguide, wherein the second coupling portion is located on a side that is of the first coupling portion and that is away from the substrate, and wherein the first coupling portion and the second coupling portion are configured to implement optical coupling between the first waveguide and the second waveguide;
a second coupling structure comprising:
a third coupling portion of the first waveguide; and
a fourth coupling portion of the third waveguide, wherein the fourth coupling portion is located on a side that is of the third coupling portion and that is away from the substrate, and wherein the third coupling portion and the fourth coupling portion are configured to implement optical coupling between the first waveguide and the third waveguide; or
a third coupling structure comprising:
a fifth coupling portion of the first waveguide;
a sixth coupling portion of the second waveguide, wherein the sixth coupling portion is located on a side that is of the fifth coupling portion and that is away from the substrate; and
a seventh coupling portion of the third waveguide, wherein the seventh coupling portion is located on a side that is of the sixth coupling portion and that is away from the substrate, and wherein the third coupling structure is configured to implement optical coupling between the second waveguide and the third waveguide.

13. The chip of claim 1, wherein the receiver comprises a photodetector, and wherein the photodetector comprises:
a light absorption structure, wherein a material of the light absorption structure is germanium;
a first doped structure having a first doping type; and
a second doped structure having a second doping type that is opposite to the first doping type, wherein the first doped structure and the second doped structure are respectively located on two sides of the light absorption structure.

14. The chip of claim 1, further comprising at least one of a balanced-unbalanced converter or a junction structure located on the first side, wherein the junction structure comprises:
a third doped structure having a first doping type; and
a fourth doped structure having a second doping type that is opposite to the first doping type.

15. The chip of claim 1, wherein the transmitter comprises at least one of an electro-optic modulator, a laser diode, or an optical amplifier, and wherein the receiver comprises at least one of a photodetector or an optical amplifier.

16. An optoelectronic module comprising:
a circuit board;
a chip connected to the circuit board, wherein the chip comprises:
a substrate comprising:
a first side;
a first region;
a second region adjacent to the first region; and
at least five side walls comprising a first side wall located in the first region and facing the second region;
a transmitter located on the first side and in the first region; and
a receiver located on the first side and in the second region; and
a housing enclosing the circuit board and the chip.

17. The optoelectronic module of claim 16, wherein the at least five side walls further comprise:
a second side wall located in the first region and away from the second region, wherein the second side wall comprises:
a first part located opposite from the first side wall; and
a second part;
a third side wall located between the first side wall and the second side wall and in the first region;
a fourth side wall located in the second region, away from the first region, and located opposite from the second part;
a fifth side wall located between the fourth side wall and the first side wall and in the second region; and
a sixth side wall comprising:
a third part located opposite from the third side wall; and
a fourth part located opposite from the fifth side wall.

18. The optoelectronic module of claim 17, wherein in a plane parallel to a surface of the substrate, a first size of the first side wall is greater than or equal to half of a second size of the second side wall.

19. The optoelectronic module of claim 16, wherein the chip further comprises an optical coupling interface, and wherein the optoelectronic module further comprises at least one of an optical fiber array connected to the optical coupling interface, a trans-impedance amplifier connected to the chip, or a driver connected to the chip.

20. A communication device comprising:
a processing chip; and,
an optoelectronic module is connected to the processing chip, and comprising:
a circuit board; and
a chip connected to the circuit board, wherein the chip comprises:
a substrate, comprising:
a first side;
a first region;
a second region adjacent to the first region; and
at least five side walls comprising a first side wall located in the first region and facing the second region;
a transmitter located on the first side and in the first region; and
a receiver located on the first side and in a the second region; and
a housing enclosing the circuit board and the chip,
wherein the second region is adjacent to; the first region, and
wherein a the first side wall is located on a side of the first region facing the second region.
